(19) United States
(12) Patent Application Publication
(10) Pub. No.: US 2022/0335272 A1
(43) Pub. Date: Oct. 20, 2022

(54) FAST SPARSE NEURAL NETWORKS

(71) Applicant: DeepMind Technologies Limited, London (GB)

(72) Inventors: Erich Konrad Elsen, Naperville, IL (US); Trevor John Gale, San Francisco, CA (US); Marat Dukhan, Mountain View, CA (US)

(21) Appl. No.: 17/763,924

(22) PCT Filed: Sep. 23, 2020
(86) PCT No.: PCT/EP2020/076587

§ 371 Date: Mar. 25, 2022

Related U.S. Application Data
(60) Provisional application No. 62/905,888, filed on Sep. 25, 2019.

(51) Int. Cl. G06N 3/04; G06F 17/16

(52) U.S. Cl. CPC G06N 3/04; G06F 17/16

(57) ABSTRACT

A neural network system includes at least one layer which applies a 1×1 convolution to a dense activation matrix, using a kernel defined by a sparse weight matrix. The layer is implemented by a processor with access to a sparsity dataset which indicates where the null weights are located in the weight matrix. The processor selects the feature values corresponding to the other weights from a memory unit configured to store the activation matrix, and then uses these extracted feature values for calculating the convolved values.

### BACKGROUND

This specification relates to neural network systems, particularly ones which are capable of implementation on processor devices with restricted memory and/or processing power, such as mobile devices.

Neural networks are machine learning models that employ one or more layers of units or nodes to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

Many neural networks include a convolutional layer having an input defined based on an array of elements, and an output also based on the array of elements. Typically, the array is a two-dimensional array, such as a rectangular array (e.g. a square array) having a width of W columns and a height of H rows. Each element is associated with an “input channel”, which is a feature vector composed of C′ feature values (where C′ is an integer, typically greater than one). The HW input channels are the input to the convolutional layer. Thus, the set of input channels constitutes an activation matrix with C′×HW components. For each element, the convolutional layer multiplies the respective feature vectors of a respective n×m portion of the array including the element, with a kernel to form a respective “output channel” for the element. The output channel for each element has C convolved values (where C is an integer, typically different from C′). A non-linear function (activation function), such as a Rectified Linear (ReLU) activation function, is typically applied to each of the C convolved values of the output channel of the element.

In one example, referred to as a “1×1 convolutional layer”, n and m are equal to one, such that the only input channel on which the output channel of the element of the array depends is the input channel for that same element. In this case, the kernel applies a C′×C weight matrix of weight values (“weights”) to the input channel of the element, before applying the activation function (if any) to each convolved value, to generate the output channel of the element.

Convolutional neural networks (CNNs), that is neural networks including at least one convolutional layer, have proven to be excellent at solving a diverse range of tasks. In many of these architectures, inference time, floating-point operations (FLOPs) and parameter counts are dominated by the 1×1 convolutions, which are equivalent to matrix-matrix multiplications.

### SUMMARY

This specification describes a neural network system implemented as computer programs on one or more computers in one or more locations.

In general terms, the disclosure proposes that a 1×1 convolutional layer applied to a dense activation matrix (i.e. substantially all the C′ feature values of each of the H×W elements, are used in the process of generating the respective output channels of the elements), uses a kernel defined by a sparse C′×C weight matrix. That is, more than half of the values of the weight matrix are “null” weights, i.e. weights which are not used in the calculation of the convoluted values and which can be considered as being zero. By providing a processor with a sparsity dataset which is an indication of where the null weights are located in the weight matrix, the processor selects (only) the feature values corresponding to the other weights (the “non-null weights”, defined as those weights which are not null weights) from a memory unit configured to store the activation matrix, and then uses (only) these extracted feature values for calculating the convolved values. This may be done highly efficiently (e.g. in parallel, or successively at very short time intervals) for corresponding convolved values for each of a plurality of different elements of the array, since all require the same corresponding weights. That is, the corresponding convolved values for the different elements depend on the same weights.

The plurality of elements may located in the same row of the array, i.e. they may be a “row vector” of elements, for example as a series of consecutive elements in that row. The selection of the plurality of elements as elements of the same row is particularly motivated in the case that, as in many known memory units, the memory unit used to store the feature values has a memory layout which is in a CHW-format. In this case, the calculation of the convolved vectors may be efficiently performed with an inner loop for successive (normally non-overlapping) row vectors of elements in the same row, and an outer loop for successive rows. Note that in implementations the memory unit may be implemented as multiple physically-separate memory devices.

The memory unit storing the activation matrix may be referred to as the feature value memory unit. The weight values are stored in another memory unit referred to as the weight memory unit. In implementations the weight memory unit may be the same memory device(s) as those implementing the feature value memory unit, or different memory device(s).

The subject matter described in this specification can be implemented in particular embodiments so as to realize one or more of the following advantages. First, the weight memory unit only has to store the non-null weights, and thus the memory requirement of the weight memory unit is reduced compared to that of a conventional neural network with a dense weight matrix having the same dimensions. Secondly, the number of multiplication and/or division operations to generate the output channels based on the activation matrix is reduced compared to those of the conventional convolutional layer of a neural network, leading to greater energy efficiency and greater processing speed. Thirdly, since multiple convolved values are calculated in parallel, efficient usage is made of parallel processing hardware. Having the memory unit storing the feature values in a CHW memory layout is particularly efficient if the processor is a GPU (Graphics Processing Unit) or other special-purpose hardware. For example, a CHW memory layer is particularly suited to being implemented in special-purpose hardware that performs matrix multiplications in hardware, e.g., a Tensor Processing Unit (TPU) or another hardware machine learning accelerator. Experimentally, it is found that all these advantages can be achieved with surprisingly little degradation of performance compared to the conventional neural network, e.g. provided the proportion of null weights (sparsity) is not greater than 95% in the proposed neural network.

For example, for some known test problems, the inventors have experimentally found the surprising result that selecting at least 70 and/or not more than 95% of the weights to be null (i.e. the sparsity is in a “sparsity range” of 70-95%) in at least one convolutional layer of a neural network trained to solve a standard test problem, reduces the number of parameters of the neural network by a factor of over two, and reduces the number of calculations (floating point operations—FLOPS) performed by the neural network to generate an output from an input by a factor of up to three, while reducing the performance of the neural network by less than 1%. It was also found that the processing time of the neural network was reduced by a factor of between 1.3 and 2 when the neural network is implemented on a low-power processor, such as the CPU of a mobile device such as a mobile phone, tablet computer or other form of mobile client device. This makes the present neural network particularly suitable for such devices. While sparsity in a neural network is not an entirely new concept, it has commonly been disregarded as a practical means of accelerating models because of a common misconception that sparse operations cannot be fast enough to achieve actual speedups during interference. The present experiments show that this is not the case. One reason for this is that the sparsity is provided in these experiments as a sparse weight matrix is combination with a dense activation matrix. Also, while prior work has usually focused on extremely sparse problems (sparsity over 99%), the range of sparsity used in the experiments is lower.

Each non-null weight may take any value (e.g. a floating-point value, or any integer value in a pre-defined range of integers), optionally even including zero in some implementations; that is, some of the non-null weights may be equal to zero in these implementations, though the implementation of the neural network does not employ prior information that they are zero. Typically, the weights will be generated during a training procedure, and in principle the training procedure may be such as to generate some weights equal to zero without those weights being labelled as null weights, and thus without being included in the indication of the null weights. Alternatively, in other implementations, all weights which are zero following the training (or are set to zero because following the training they obey a predetermined criterion, such as having a magnitude below a pre-determined threshold following the training) are labelled as null weights and included in the indication of null weights; in other words, all the non-null weights are non-zero in such implementations. In other implementations, the null weights may be designated prior to the training, such that the training procedure only modifies the values of the non-null weights.

Note that although the present disclosure proposes a sparse weight matrix, there is substantially no sparsity in the activation matrix (the input to the convolutional layer). Thus, the convolutional layer of the neural network is configured to successively select successive row vectors of elements (e.g. each having the same number of elements) from the array, and each row vector is processed in parallel as described above, such that the convolutional layer of the neural network eventually processes a plurality of successive row vectors which collectively include all elements of the array. There may be substantially no “null” feature values (i.e. feature values upon which no convolved value depends).

It is not necessary for all the layers of the neural network to use the principles described above. For example, the input layer of the neural network may be fully-connected, and/or an output layer of the neural network may be fully-connected. In other words, sparsity may be provided in a specific location in a neural network, a location motivated by the abilities of known computer processors which are capable of parallel processing.

Optionally, the weight matrix may have a certain amount of regularity. For example, for each a plurality of rows of the weight matrix (corresponding respectively to a plurality of the convolved values of each element), the non-null weights may be in the same positions (i.e. correspond to the same sub-set of the feature values of the input channel of each element). Thus, different ones of the convolved values for a given element depend on the same sub-set of the feature values of the input channel of the element. In this case, the efficiency of the calculation may be further improved by calculating those convolved values of the output channels for the row vector in parallel (as a “block”). Furthermore, the sparsity dataset may be reduced in size for a given number of non-null weights due the regularity of the arrangement of the non-null weights.

To express this differently, the rows of the weight matrix may be vertically partitioned into groups of rows of weights (“weight rows”), where each group may be an equal number of weight rows which is at least two, and may consist of consecutive weight rows. For each group, the non-null weights of all the weight rows of that group may be in the same positions along the weight row (i.e. correspond to the same sub-set of feature values). In this case, when processing the row vector of elements to generate the corresponding convolved values, the groups of weight rows may be processed successively, but the weight rows of each group may be processed in parallel to generate the corresponding convolved values.

The values of H and W may be any integers, but typically each would be at least 10. The number of feature values per input channel, C′, is typically at least 2, and may be greater than two. The number of elements per row vector is at least 2, and more typically is at least 3 (such as 4 or 8) or at least 8 (such as 16).

Preferably, during the generation of each convolved value for the plurality of elements, once the feature values of those plurality of element for which the corresponding weights are non-null are extracted (e.g. simultaneously) from the memory unit, the extracted features values are stored (e.g. simultaneously) in a cache memory. The extraction and storage is preferably not performed, however, in respect of feature values which were stored in the cache memory during the generation of preceding convolved values for the plurality of elements. This results in another saving of computational time.

As well as extracting from the memory unit the features values for the plurality of elements for which the convolved values are presently being calculated and writing them to the cache memory, the corresponding feature values for a plurality of additional elements are also read (e.g. simultaneously) from the memory unit and written (e.g. simultaneously) into the cache memory. The convolved values of the plurality of additional elements not being generated in parallel with the convolved values for the plurality of elements, e.g. this may be done during a separate processing loop, but the fact that they have been pre-fetched means that when it is time to calculate the convolved values for those elements, the feature values for them are already present in the cache memory. This reduces the computational time required to generate the convolved values for those additional elements.

Concepts proposed in this document can be expressed as methods for implementing a neural network, or alternatively as methods for training the neural network. This training process typically includes deriving the weight matrix.

The training may include designating at least some of weights of the weight matrix as the null weights (i.e. selecting some of the components of the weight matrix to be null weights). This may be done by performing a training procedure to obtain the weights, identifying resulting weights which meet a certain criterion (such as having a magnitude below a threshold), and designating the identified weights as the null weights. A more sophisticated criterion for identifying the resulting weights to designate as null weights may take multiple resulting weights into account together, for example so as to ensure that the identified resulting weights are ones with relatively low magnitude subject to a constraint on the regularity of the positions of the null weights in the weight matrix. Alternatively, some or all of the null weights may be pre-designated (i.e. the sparsity dataset may exist prior to the training of the non-null weights), such as to ensure that that there is the regularity in the arrangement of the non-null weights discussed above.

Alternative expressions of the present concepts may be in terms of computer systems, comprising one or more computers, in one or more locations, arranged to perform the methods, or computer program products comprising instructions, such as non-transitory computer storage media (memory devices) storing program instructions, or downloadable software comprising instructions, where the instructions, when executed by one or more computers, cause the computers to implements any of the methods described above.

Implementations of the neural network have many applications. In broad terms the system can be used in any neural network which receives input data having a dimensionality corresponding to the dimensionality of the array (e.g. two-dimensional).

The input data may represent, for example, a still or moving image, in which case values of the data may represent pixel values. The input data may be real-world data, such as data collected by one or more sensor devices, such as one or more still and/or video cameras.

The neural network it may be employed, for example, as a classifier, trained to classify the input data into one or more classes. For example, the neural network system may be used to classify images (e.g. of a real-world or simulated environment) into one of a pre-determined plurality of classes.

Alternatively, the neural network may be used, for example, as a generative model, for example to generate examples conditioned upon side information. Alternatively, it may be used to score the quality of already generated examples, i.e., in terms of how well the examples match training data.

Alternatively, the neural network may be used for reinforcement learning, for example to generate control data for controlling an agent (e.g. a robot) moving in a real-world or simulated environment. Alternately, the neural network system may be trained to generate data predicting a future image or video sequence seen by a real or virtual camera associated with a physical object or agent in a simulated or real-world environment.

### BRIEF DESCRIPTION OF THE DRAWINGS

Examples of the present disclosure will now be described for the sake of example only with reference to the following drawings, in which:

FIG. 1 shows a neural network employing a method presently disclosed.

FIG. 2 shows a computer system for implementing the neural network of FIG. 1.

FIG. 3 illustrates a first convolution operation performed by a layer of the neural network of FIG. 1.

FIG. 4 illustrates a second, alternative convolution operation performed by a layer of the neural network of FIG. 1.

FIG. 5, which is composed of FIGS. 5(a)-5(e), illustrates schematically a sequence of memory operations performed during the performance of the convolution operation of FIG. 3.

FIG. 6 shows the steps of a method performed by the neural network of FIG. 1 during a process such as that of FIG. 5.

Like reference numbers and designations in the various drawings indicate like elements.

### DETAILED DESCRIPTION

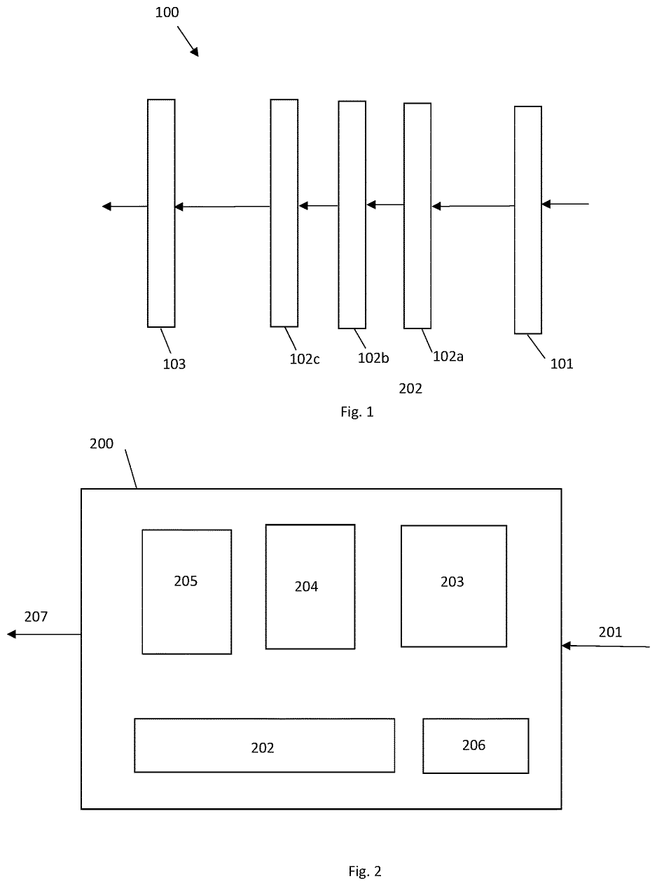

FIG. 1 shows a neural network 100 which is an example of the present disclosure. The neural network 100 may be implemented by one or more computer systems in one or more locations.

The neural network 100 comprises an input layer 101, an output layer 103 and one or more hidden layers 102a, 102b, 102c. The input layer 101, hidden layer(s) 102a, 102b, 102c and output layer 103 are arranged in a sequence. The output of each layer except the output layer 103 provides the input for the next layer of the sequence. One of more of the input layer 101, hidden layer(s) 102a, 102b, 102c and output layer 103 are convolutional layers. Indeed, they may all be convolutional layers, though typically at least the output layer 103 is not. Each convolutional layer receives input defined based on an array (typically a two-dimensional array) of elements. For each element there is a respective input channel which is a feature vector composed of C′ feature values. Similarly, for each element the convolutional layer generates a respective output channel having C values referred to as “convolved values”. Each convolutional layer employs a respective kernel defined by a weight matrix.

The input to the input layer 101 is data defining an image, such as data which for each of an array of pixels specifies values for one or more values. The pixels may correspond to respective ones of the elements. For example, C′ may be 3 for this layer, and the feature values of the input channel for each element may be respectively the intensity of red, green and blue channels.

At least one of the layers, particularly one of the hidden layer(s) 102a, 102b, 102c is a 1×1 convolutional layer. In the case of a 1×1 convolutional layer, the output channel for each element depends only upon the input channel for the element. That is, the kernel does not contain weights which cause a component of the output channel for one element to depend upon the input channel of another element.

As described below, one or more of the layer(s) of the neural network 100 which implement a 1×1 convolution may be implemented using a kernel which exhibits “sparsity” (i.e. at least a certain proportion of the weights taking zero values, e.g. at least half), particularly one of the hidden layer(s) 102a, 102b, 102c. However, not all the layers of the neural network may exhibit sparsity.

Firstly, the input layer 101 may comprise a kernel which does not exhibit sparsity. Its overall contribution to the parameter count, FLOP count, and runtime is small. Instead, the input layer 101 may employ a dense convolutional kernel, and take an image as its input.

Also, one or more of the layers 101, 102a, 102b, 102c, 103 may implement a “squeeze and excitation” (SE) layer, as described in “Squeeze and excitation networks”, Jie Hu et al, (2019). In such a layer, an input to the layer is mapped to feature maps denoted U (e.g. by a convolution), and the feature maps are subject to a “squeeze” operation which produces a channel descriptor by aggregating feature maps across their H×W spatial dimensions, to produce an embedding of the global distribution of channel-wise feature responses. This aggregation is followed by an “excitation” operation, which takes the embedding as an input and produces a collection of per-channel weights, which are applied to the feature maps U to generate the output of the SE layer. If such a SE layer is present in the neural network 100, this also may not employ a sparse kernel as described below, since experiments have shown that typically they contribute less than 1% of the total FLOPs of dense models in which they are conventionally used.

Also, the last layer 103 of the neural network 100 may be implemented as fully-connected layer, rather than a convolutional layer. Again, it is known from experiment that in conventional models a fully-connected output layer contributes insignificantly (<1%) to the total FLOP count, but does contribute a significant fraction (20-50%) of total parameters, especially if the training of the neural network is such that other layers of the neural network are pruned.

FIG. 2 illustrates a computer system 200 for implementing the neural network 100 of FIG. 1. The computer system 200 receives data input 201 which may be image data describing one or more images. The computer system 200 comprises a processor 202 and memory units 203, 204, 205. The processor 202 may be one capable of processing multiple computational threads simultaneously in parallel. A first of the memory units 203, 204, 205 is a program memory unit 203 which stores program instructions operative to control the processor 202 to implement the neural network 100, and in particular to perform the convolution operations of the hidden layers 102a, 102b, 102c described below. A second of the memory units is a weight memory unit 204 stores weights defining the operations performed by the layers of the neural network 100. For each layer, there is a respective weight matrix composed of weights. The weight memory unit 204 may also store, for each layer, a respective sparsity dataset which indicates for each output channel the one or more non-null weight values of the respective weight matrix.

The third of the memory units is a feature value memory unit 205 which stores data input to and output from each of the layers. Upon receiving the data input 201, the data is stored in the feature value memory 205.

The data in the data input 201 and stored in the feature value memory 205 may be in the standard HWC layout in which the values for different channels corresponding to one spatial location are adjacent in memory. That is, denoting the number of elements per row of the array as W, the number of rows in the array by H, and the number of channels per element by C, the memory location (i.e. the offset distance from some arbitrary location in the memory space) for the value of the c-th channel of the element at position (h, w) in the array, may be expressed as h*(W)*(C)+w*(C)+c. Upon receiving the data input 201, the data input 201 may be stored, typically still in the HWC format, in the feature memory unit 205.

To implement one of the layers of the neural network 100, the processor 202 may transfer successive portions of the data describing the input to that layer from the feature memory unit 205 to a cache memory 206 of the processor 202. In the case of a layer exhibiting sparsity, for each element the transfer may be performed in multiple steps, in which each of which only a subset of the feature values of input channel for that element is transferred to the cache memory 206, as required to generate a portion of the output channel for the element. To allow the convolved values for multiple elements to be generated together (e.g. in parallel), feature values for the multiple elements may be transferred from the feature memory unit 205 to the cache memory 206 simultaneously.

For each layer (except optionally for the output layer 103), the convolved values of the respective output channel for each element are stored in the feature value memory unit 205. The output channels are subsequently read by the processor 202 from the feature value memory unit 205, and used by the processor 202 as input data for the successive layer of the neural network 100. As described below, the output channels for one or more of the layers of the neural network 100, such as the input layer 101 and/or one or more of the hidden layers 102a, 102b, 102c, may be stored in the feature value memory unit 205 in a CHW format, also called here a CHW layout. In the CHW layout, the values of all the spatial locations for one channel are adjacent in memory. In the CHW layout, the memory location (offset from an arbitrary position in the memory space) of the c-th channel of the element at position (h,w) in the H×W array is c*(W)*(H)+h*(W)+w. It is convenient for sparse convolutional operations if the input data is in the CHW format for the one or more of the hidden layers 102c, 102b, 102c and output layer 103, and in particular for the convolutional layer 102a immediately following the input layer 101.

The output channels for the output layer 103 are transmitted from the computer system 200 as the output data 207. The output may be for example represent a classification of the image data 201. Alternatively, if the data input 201 is side-data and the neural network 100 is a generative network, the output data 207 may be a dataset representing an image or a signal such as a sound waveform. Alternatively, if the data input 201 is sensor data describing an environment, e.g. an image of a real-world environment collected by a still or video camera, the output data 207 may be control data which is transmitted to an agent in order to control the agent to interact with the environment, e.g. move (by translation, rotation and/or reconfiguration) within the environment. Alternatively, if the data input 201 is data representing a portion of natural language (e.g. a sequence of letters or a sound signal collected by a sensor when the natural language is spoken), the output data 207 may be modified natural language, such as translation of the natural language, and may again be a sequence of letters or a sound signal.

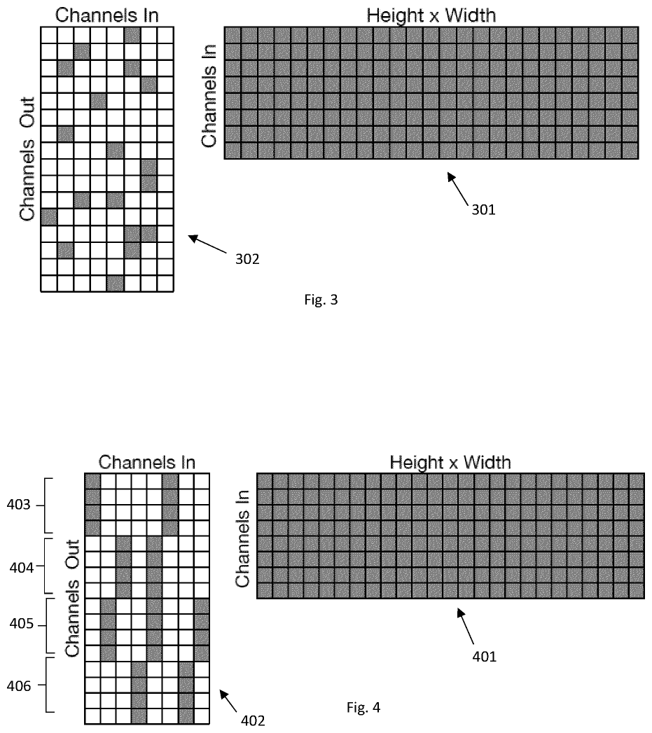

Turning to FIG. 3, a diagram is shown explaining the performance of a 1×1 convolution operation by one of the layers of the neural network 100, e.g. by one of the hidden layers 102a, 102b, 102b, using the sparsity principles disclosed here. The input to the convolution operation is activation matrix 301 in a CHW format. Each column of the activation matrix 301 represents an input channel to one of the elements of the array, composed of C′ feature values. Respective feature values of the activation matrix 301 are illustrated in FIG. 1 by respective boxes in one of the columns. In FIG. 3, the activation matrix 301 is denoted as having number of columns “height×width” (i.e. HW) and a number C′ of rows denoted “channels in”. The activation matrix 301 is dense in the sense that substantially none of the feature values for any channel of any element is “null”, i.e. known in advance to be zero (e.g. none of the values, or no more than 1% of the values, is known in advance to be zero). Indeed all, or substantially all, the C′×HW values may actually be non-zero. Non-null feature values are denoted in FIG. 3 by a shaded box, i.e. all the boxes of the activation matrix 301 are shaded.

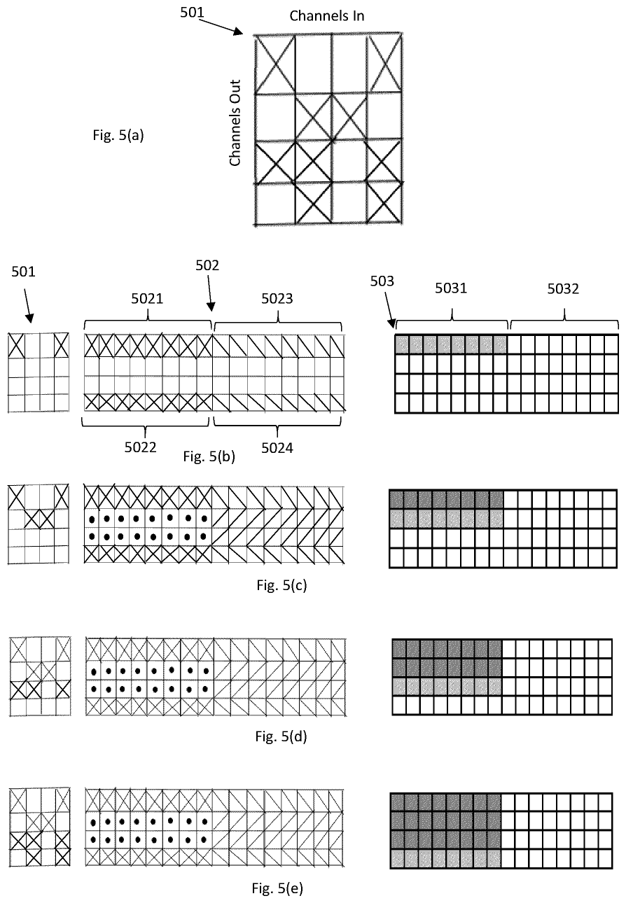

The kernel for the 1×1 convolutional layer is denoted by the C×C′ weight matrix 302, where C is the number of convolved values in the output channel of each element. C may be the same as, or different from, C′. Values in the weight matrix 302 which are zero (“null values”) are denoted by unshaded (white) boxes, while non-zero values (“non-null values”) in the kernel matrix are denoted by shaded boxes. The proportion of non-null values is small, e.g. in the range 25%-10%. The convolution operation consists of the multiplication of the weight matrix 302 by the activation matrix 301. This is described below with reference to FIG. 5.

FIG. 4 illustrates an alternative form of the 1×1 convolution operation which may be performed by one of the hidden layers 102a, 102b, 102b. The activation matrix 401 is the same as in FIG. 3, but, in contrast to FIG. 3, in the case of FIG. 4 the rows of the weight matrix 402 (“weight rows”) are vertically partitioned into groups 403, 404, 405 406. For each group, the non-null weights of all the weight rows of that group are in the same positions along the weight row (i.e. correspond to the same sub-set of feature values). Each group may consist of an equal number of weight rows which is at least two (in FIG. 4, each group 403, 404, 405, 406 has four rows). As illustrated in FIG. 4, the weight rows of each group 403, 404, 405, 406 are consecutive weight rows, but in alternative arrangements the rows of the groups may be interleaved with each other.

When processing each column of the matrix 401 (i.e. the input values for each element) to generate the corresponding convolved values, the weight rows of each group may be processed in parallel to generate the corresponding convolved values. However, different groups of weight rows may be processed successively.

FIG. 5 shows the memory read and write operations for evaluation of a kernel in one of the 1×1 convolution operations of FIG. 3. For simplicity, the number C′ of rows of the activation matrix (i.e. the number of channels of the input for each element) in this example is 4, as is the number C of output channels for each element. However, the scheme of FIG. 5 is readily extended to cases in which the values C′ and C are any positive integers (e.g. C′=8 and C=16 as in FIGS. 3 and 4), equal to each other or different. Specifically, FIG. 5(a) shows an example weight matrix 501, with non-zero (non-null) elements shown by boxes containing crosses, and zero (null) elements shown by uncrossed boxes. For example, the fourth output channel (fourth row) has non-null weight values only for the second and fourth input channels.

FIG. 5(b)-(e) shows a sequence of operations in which the four channel values for eight elements of the array are processed together, but the number of elements processed together may be different. For example, 16 elements may be processed together, which may correspond to one cache line in the cache memory 206. The memory space of the cache memory is denoted 502, having a number of rows (cache lines) which is (at least) equal to the number of feature values in each input channel. In each row there are a plurality of memory locations which are each configured to be able to store a corresponding feature value. FIGS. 5(b)-(e) also show a memory space 503 of the feature value memory unit 205 for storing the convolved values which are the output of the 1×1 convolution layer.

In a first step, shown in FIG. 5(b), the processor 202 determines from the sparsity dataset the positions of the non-zero weights in the first row of the weight matrix. In this example, the first row of the weight matrix 501 has non-null values at the first and fourth positions. For a set of eight elements of the array, the processor 202 reads the feature values corresponding to these non-zero weights from the feature value memory unit 205, and writes them into the first eight positions of the memory space 502 of the cache memory 206, in the respective rows of the memory space 502 corresponding to the non-zero weights in the first row of the weight matrix 501. That is, the first feature values for the set of eight elements are respectively written into the first eight positions 5021 of the first row of the memory space 502, and the fourth feature values for set of eight elements are respective written into the first eight positions 5022 of fourth row of the memory space 502. The features values written to the locations 5021, 5022 are denoted by crossed boxes. These read and write operations are performed substantially simultaneously for the eight elements (spatial locations in the array).

Optionally, for each of the non-null weight values in the first row of the weight matrix 501 (i.e. the first and fourth weights), the processor also reads the corresponding feature values (i.e. the first and fourth feature values) for a second set of e.g. eight elements, and writes them to the next eight locations 5023, 5024 of the corresponding rows of the memory space 502 (i.e. the first and fourth rows). They are shown in FIG. 5(b) as boxes having a single top-left to bottom-right diagonal line through them. These pre-fetched feature values are used later (after all the convolved values for the first set of eight elements have been generated) to generate the convolved values for the second set of elements.

For each of the first set of eight elements, the processor 502 forms the respective convolved value by multiplying each non-null weight in the first row of the weight matrix 501 by the feature value for that element in the row of the memory space 502 corresponding to non-null weight, and accumulating (adding) the results. The processor 202 then writes the respective convolved value for each of these eight elements to the first eight positions 5031 of the portion 503 of the memory space of the feature value memory unit 205. Optionally, a non-linear function included in the 1×1 convolution (e.g. an ReLU function) may be performed to each of the convolved values. Thus, the process illustrated in FIG. 5(b) has generated the first convolved values for the output channel for the first set of eight elements. The convolved values for the first set of eight elements may be generated in parallel (or successively at short intervals) and may be written substantially simultaneously into the feature value memory unit 205.

As noted above, the processor 202 may optionally have already written the first and fourth feature values for the second set of eight elements to the eight respective memory locations 5023, 5024. In this case, the processor 202 may optionally generate the convolved values for the second set of eight elements by the same process. That is, for each of the second set of eight elements, the processor 202 forms the respective convolved value by multiplying each non-null weight in the first row of the weight matrix 501 by the feature value for that element in the portion 5023, 2024 of the row of the memory space 502 corresponding to non-null weight, accumulating (adding) the results, and writing them to the next eight positions 5032 of the first row of the memory space 503. If the 1×1 convolution operation includes performing a non-linear function, this is performed on each of the convolved values. Note that this process is not illustrated in FIG. 5(a) because this process of calculating the respective convolved values for the first output channel of each of the second set of eight elements may optionally be performed after the sequence of steps shown in FIG. 5(b)-5(e) is completed.

FIG. 5(c) shows how the same process illustrated in FIG. 5(b) is performed to calculate the second convolved value for the output channel of the first set of eight elements. In this example, the non-null weight values are in the second and third positions of the second row of the weight matrix 501, so the processor reads the second and third feature values of the input channel for the first set of eight elements from the feature value memory unit 205, and writes them into the positions in the memory space 502 shown by the dots. In this example, the non-null weights of the second row of the weight matrix 501 happen to be in different positions from the non-null weights of the first row of the weight matrix 501, but if any non-null weight is in the same position (i.e. relates to the same input channel) then the read and write operation for that input channel can be omitted, since the memory space 502 already contains those feature values.

Optionally, the second and third feature values for the second set of eight elements are written into the next eight positions of the corresponding rows (i.e. the second and third rows) of the memory space 502 (as indicated by a single diagonal line from bottom-left to top-right. Then the processor 202 calculates the respective second convolved value of the output channel for each of the first set of eight elements by multiplying the non-null weights in the second row of the weight matrix 501 by the corresponding feature values for the first set of eight elements, and adding the results.

FIGS. 5(d) and 5(e) respectively show how the processor generates the convolved values for the third and fourth convolved values of the output channel of the first set of eight elements. Note that after the processes shown in FIGS. 5(b) and 5(c), all the feature values for the first set of eight elements (spatial locations) are in the cache memory 206, so the processor 202 can generate the convolved values for the remaining output channels without reading any more data from the feature value memory unit 205. To generate the third and fourth convolved values of the output channel of each of the first set of eight elements, the processor 202 respectively multiplies the non-null weights in the third and fourth rows of the weight matrix 501 by the corresponding feature values for the first set of eight elements, and adds the results. This means that the loading of the feature values to perform the multiplication in steps 5(d) and 5(e) is fast, despite the feature value memory unit 205 and the cache memory 206 being random access.

In the sequence of steps shown in FIGS. 5(b)-5(e), the outer loop is over columns and the inner loop is over rows. This allows each strip of 16 spatial locations in the activation matrix to remain in the cache memory 206 until it is no longer needed. The steps in FIGS. 5(b) and 5(c) prime the cache memory 206, while subsequent steps FIGS. 5(d) and 5(e) load all feature values from the cache memory 206.

If there is known to be any regularity in the structure in the weight matrix 501, even a small amount, this allows the process of FIG. 5 to be varied with significant performance boosts by increasing data reuse after the weight and feature values are loaded into the registers of the processor 202. For example, as described above in relation to FIG. 4, multiple output channels of the weight matrix may have the same pattern of zero/non-zero weights. Alternatively or additionally, multiple columns of the weight matrix may have the same pattern of zero/non-zero weights. Constraining the training process which generates the weight matrix so as to produce a sparsity pattern so that multiple output or input channels all share the same zero/non-zero pattern creates ‘blocks’ in the weight matrix, as shown in FIG. 4 in the case that the block is group of multiple rows with the same sparsity pattern. Creating blocks in the output channel dimension, as shown in FIG. 4, allows for more data reuse than forming blocks in the input channel dimension. Experiments were performed which showed that either choice has the same effect on accuracy, but arranging for multiple rows of the weight matrix to have the same pattern (as in FIG. 4) leads to greater processing efficiency so this is preferred. In certain experiments, the weight matrix was trained with the constraint that the groups consisted of 2 rows, or that the groups consisted of 4 rows. The inner loop in this case may include generating the output channel for all the rows of a corresponding group. For example, in the case that each group contains 2 weight rows, a single inner loop, performed for a feature vector of the array (e.g. a row of eight elements of the array), may generate the corresponding two convolved values for the output channels of the set of elements. In effect, the scheme of FIG. 5 is varied such that each of the stages of FIGS. 5(a) to 5(b) is replaced in one which the all the weight rows for one of the groups are used to generate all the corresponding convolved values.

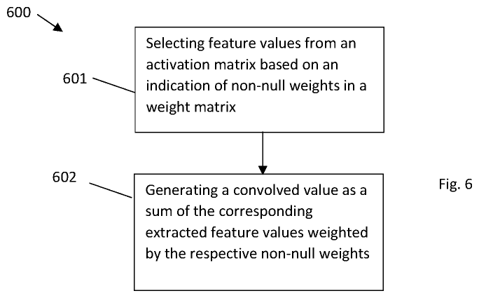

A method 600 of generating a convolved value in the process illustrated in FIG. 5 is summarized in FIG. 6. In step 601, for each convolved value, one or more feature values are obtained from an activation matrix based on the sparsity dataset (which serves as an indication of the non-null weights in the weight matrix corresponding to each convolved value). In step 602, the convolved value is generated as a sum of the corresponding extracted feature values weighted by the respective non-null weights.

Experiments were performed demonstrating that large savings in computational burden and memory requirements can be achieved using the techniques explained above. Three factors particularly contribute to this:

1. Though the weight matrix is sparse, the activation matrix is dense. This means that the processor 202 can perform vector loads from the activation matrix and process multiple spatial locations simultaneously.

2. By processing the matrix in the right order the system can keep in the cache memory values that will be randomly accessed. Note that random access from the cache memory 206 can be performed more quickly than from the feature value memory unit 205.

3. Particularly when the number of input channels is small, the prefetching of feature values from the activation matrix for the second set of elements further reduces the number of cases in which the cache memory 206 does not contain required feature values when the convolved values for the second set of elements are to be calculated, such that a value has to be obtained from the feature value memory unit 205.

The experiments demonstrated that for a constant computational budget, sparse convolutional networks are more accurate than dense ones, such as by a factor of 1.3-2.4 as measured by wall clock time, while needing only 66% as many parameters—equivalent to approximately one entire generation of improvement.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially be claimed as such, one or more features from a claimed combination can in some cases be excised from the combination, and the claimed combination may be directed to a sub-combination or variation of a sub-combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method of implementing a neural network, the neural network comprising a plurality of layers including at least one sparse 1×1 convolutional layer, the input of the convolutional layer comprising, for each of a plurality of elements arranged in an H×W array, a respective input channel of feature values,
the sparse 1×1 convolutional layer being configured to apply a sparse 1×1 convolution to the input channels to form respective output channels each composed of a plurality of convolved values, the sparse 1×1 convolution being defined by a sparse C×C′ weight matrix having a plurality of null weights which are equal to zero and a plurality of non-null weights, and the input channels constituting a dense C′×HW activation matrix having a feature value defined for each element of the activation matrix,
the method comprising:
obtaining an indication of the null weights of the weight matrix; and
processing the sparse C×C′ weight matrix in conjunction with the dense C′×HW activation matrix by, for elements of a row vector comprising a plurality of the elements in a row of the activation matrix, generating the convolved values for the plurality of elements by:
(a) extracting corresponding feature values of the input channels from a memory unit storing the activation matrix, the corresponding feature values being feature values for which according to the indication the corresponding weight of the weight matrix is a non-null weight, and
(b) forming a corresponding sum of the corresponding extracted feature values weighted by the respective non-null weights.

2. A method according to claim 1 in which the null weights constitute substantially 70-95% of the components of the weight matrix.

3. A method according to claim 1 in which an output layer of the neural network is fully connected.

4. A method according to claim 1 in which the memory unit has a CHW memory layout.

5. A method according to claim 4 in which the processing is performed with an inner loop for successive row vectors of elements in the same row, and an outer loop for successive rows.

6. A method according to claim 1 in which the processing is performed repeatedly for successive row vectors, the row vectors collectively including the whole array of elements.

7. A method according to claim 1, the neural network further including an output layer following the convolutional layer and arranged to generate one or more output values, each output value being determined based on all the convolved values of all the elements.

8. A method according to claim 1, in which the non-null weights are in the same positions in each of a plurality of rows of the weight matrix.

9. A method according to claim 8 in which the processing for the plurality of rows of the weight matrix is performed in parallel to generate the corresponding plurality of convolved values of the output channels for the row vector.

10. A method according to claim 1 in which during the generation of the convolved values for the plurality of elements, upon said extraction of corresponding feature values from the memory unit, the extracted features values are stored in a cache memory, the extraction and storage not being performed in respect of feature values which were stored in the cache memory during the generation of preceding convolved values for the plurality of elements.

11. A method according to claim 10 in which during the generation of the convolved values for the plurality of elements based on the corresponding feature values for the plurality of elements, the corresponding feature values for a plurality of additional elements are also read from the memory unit into the cache memory, the convolved values of the plurality of additional elements not being generated in parallel with the convolved values for the plurality of elements.

12. (canceled)

13. (canceled)

14. A system configured to implement a neural network, the neural network comprising a plurality of layers including at least one sparse 1×1 convolutional layer, the input of the convolutional layer comprising, for each of a plurality of elements arranged in an H×W array, a respective input channel of feature values,
the sparse 1×1 convolutional layer being configured to apply a sparse 1×1 convolution to the input channels to form respective output channels each composed of a plurality of convolved values, the sparse 1×1 convolution being defined by a sparse C×C′ weight matrix having a plurality of null weights which are equal to zero and a plurality of non-null weights, and the input channels constituting a dense C′×HW activation matrix having a feature value defined for each element of the activation matrix,
the system comprising a memory unit and a processing unit, the memory unit storing instructions which when implemented by the processing unit cause the processing unit to:
obtain an indication of the null weights of the weight matrix; and
process the sparse C×C′ weight matrix in conjunction with the dense C′×HW activation matrix by, for elements of a row vector comprising a plurality of the elements in a row of the activation matrix, generating the convolved values for the plurality of elements by:
(a) extracting corresponding feature values of the input channels from a memory unit storing the activation matrix, the corresponding extracted feature values being feature values for which according to the indication the corresponding weight of the weight matrix is a non-null weight, and
(b) forming a corresponding sum of the corresponding extracted feature values weighted by the respective non-null weights.

15. (canceled)

16. (canceled)

17. A system according to claim 14 in which an output layer of the neural network is fully connected.

18. A system according to claim 14 in which the memory unit has a CHW memory layout.

19. A system according to claim 18 in which the processing is performed with an inner loop for successive row vectors of elements in the same row, and an outer loop for successive rows.

20. A system according to claim 14 in which the processing is performed repeatedly for successive row vectors, the row vectors collectively including the whole array of elements.

21. A system according to claim 14, the neural network further including an output layer following the convolutional layer and arranged to generate one or more output values, each output value being determined based on all the convolved values of all the elements.

22. A system according to claim 14, in which the non-null weights are in the same positions in each of a plurality of rows of the weight matrix.

23. A system according to claim 22 in which the processing for the plurality of rows of the weight matrix is performed in parallel to generate the corresponding plurality of convolved values of the output channels for the row vector.

24. One or more computer storage media encoded with instructions that, when executed by one or more computers, cause the one or more computers to perform operations for implementing a neural network, the neural network comprising a plurality of layers including at least one sparse 1×1 convolutional layer, the input of the convolutional layer comprising, for each of a plurality of elements arranged in an H×W array, a respective input channel of feature values,
the sparse 1×1 convolutional layer being configured to apply a sparse 1×1 convolution to the input channels to form respective output channels each composed of a plurality of convolved values, the sparse 1×1 convolution being defined by a sparse C×C′ weight matrix having a plurality of null weights which are equal to zero and a plurality of non-null weights, and the input channels constituting a dense C′×HW activation matrix having a feature value defined for each element of the activation matrix,
the method comprising:
obtaining an indication of the null weights of the weight matrix; and
processing the sparse C×C′ weight matrix in conjunction with the dense C′×HW activation matrix by, for elements of a row vector comprising a plurality of the elements in a row of the activation matrix, generating the convolved values for the plurality of elements by:
(a) extracting corresponding feature values of the input channels from a memory unit storing the activation matrix, the corresponding feature values being feature values for which according to the indication the corresponding weight of the weight matrix is a non-null weight, and
(b) forming a corresponding sum of the corresponding extracted feature values weighted by the respective non-null weights.
